(19) United States
(12) Patent Application Publication
(10) Pub. No.: US 2026/0328466 A1
(43) Pub. Date: Oct. 22, 2026

(54) A SYSTEM AND A METHOD FOR EXTRACTING AIR FROM AN EVAPORATOR UNIT ASSOCIATED WITH AN AUTOMATED STORAGE AND RETRIEVAL SYSTEM

(71) Applicant: AutoStore Technology AS, Nedre Vats (NO)

(72) Inventors: Espen Verpe, Haugesund (NO); Paul Edvin Bersaas, Haugesund (NO)

(21) Appl. No.: 19/108,720

(22) PCT Filed: Aug. 17, 2023
(86) PCT No.: PCT/EP2023/072701

§ 371 Date: Mar. 4, 2025

(30) Foreign Application Priority Data
Sep. 6, 2022 (NO) 20220960

(51) Int. Cl. F25D 13/00; B65G 1/04; F25D 17/00; F25D 17/04; F25D 17/06; F25D 17/08; F25D 21/00; F25D 21/12

(52) U.S. Cl. CPC F25D 13/00; B65G 1/0464; B65G 1/0492; F25D 17/005; F25D 17/045; F25D 17/067; F25D 17/08; F25D 21/004; F25D 21/125; F25D 2317/0411

(57) ABSTRACT

The invention relates to a system for extracting air from an evaporator unit, said evaporator unit comprising an evaporator coil and being disposed in a cold room an automated, grid-based storage and retrieval system for frozen food. The system comprises an extraction fan configured to extract air from an interior of the evaporation unit to an exterior of the cold room, wherein the system is configured such that the extraction fan operates while the evaporator coil is being defrosted. The invention further relates to a corresponding method.

The present invention relates primarily to a system and a method for extracting air from an evaporator unit disposed in a cold room of an automated, grid-based storage and retrieval system for frozen food.

### BACKGROUND AND PRIOR ART

FIG. 1 discloses a prior art automated storage and retrieval system 1 with a framework structure 100 and FIGS. 2, 3a-3b disclose three different prior art container handling vehicles 201, 301, 401 suitable for operating on such a system 1. The framework structure 100 comprises upright members 102 and a storage volume comprising storage columns 105 arranged in rows between the upright members 102. In these storage columns 105 storage containers 106, also known as bins, are stacked one on top of one another to form container stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 301, 401 in a first direction X across the top of the framework structure 100, and a second set of parallel rails 111 arranged perpendicular to the first set of rails 110 to guide movement of the container handling vehicles 301, 401 in a second direction Y which is perpendicular to the first direction X. Containers 106 stored in the columns 105 are accessed by the container handling vehicles 301, 401 through access openings 112 in the rail system 108. The container handling vehicles 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 201c, 301b, 301c, 401b, 401c which enable lateral movement of the container handling vehicles 201, 301, 401 in the X direction and in the Y direction, respectively. In FIGS. 2-3b, two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lifting device 304, 404 (visible in FIGS. 3a-3b) having a lifting frame part 304a for vertical transportation of storage containers 106, e.g. raising a storage container 106 from, and lowering a storage container 106 into, a storage column 105. Lifting bands 404 a are also shown in FIG. 3b. The lifting device 304, 404 comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z (visible for instance in FIG. 1) which is orthogonal the first direction X and the second direction Y. Parts of the gripping device of the container handling vehicles 301, 401 are shown in FIGS. 3a and 3b indicated with reference numbers 304 and 404. The gripping device of the container handling device 201 is located within the vehicle body 201a in FIG. 2.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 ... n and Y=1 ... n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=18, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells within storage columns. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 3b and as described in e.g. WO2015/193278A1 and WO2019/206487A1, the contents of which are incorporated herein by reference.

FIG. 3a shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIG. 3b and as disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks; in other rail systems 108, each rail in one direction may comprise one track and each rail in the other perpendicular direction may comprise two tracks. The rail system may also comprise a double track rail in one of the X or Y direction and a single track rail in the other of the X or Y direction. A double track rail may comprise two rail members, each with a track, which are fastened together.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or a dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are, once accessed, returned into the framework structure 100. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different heights, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301, 401 lifting device (not shown in FIG. 2 but visible in FIGS. 3a and 3b), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106 and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 (shown in FIG. 1) which typically is computerized and which typically comprises a database for keeping track of the storage containers 106.

Storage and retrieval systems of the above kind could also be employed to store frozen goods, such as frozen food products. To this purpose, a temperature environment well below 0 °C is required in a region of the storage and retrieval system where frozen food products are stored. Such a system is discussed in WO2021/209648A1.

WO2015/124610A1 discloses a cooled storage system with a grid structure of storage cells and at least one remotely operated vehicle arranged to move at the top level of the grid structure. There is provided thermal insulation between the grid structure and the remotely operated vehicle.

An environment as described above is normally achieved by the continuous supply of cooling fluid, typically air, at a very low temperature. Normally, cooling air is produced in a dedicated chill plant annexed to the system. In an evaporator-based chill plant, especially one having limited size, ice formation at the evaporator coil occurs frequently and may result in a large amount of ice being formed in a matter of hours. As standard methods of dealing with ice formation within the evaporator of the chill plant have proven inadequate, it is desirable to provide a solution which offers further benefits to an owner of the storage system for frozen food products.

In a broader context of cooled storage spaces, CN114046624 discloses an outside-warehouse installation type air cooler for the refrigeration storage. Moreover, US2020071076A1 discloses an automated order fulfillment system for storing and transferring containers. The system has different temperature zones and robots and containers of the system are configured to work in these different temperature zones. Also, US4063432A discloses a cold storage installation. A part of the installation is available for rapid freezing.

### SUMMARY OF THE INVENTION

The present invention is set forth and characterized in the independent claims, while the dependent claims describe other characteristics of the invention.

First aspect of the invention relates to a system for extracting air from an evaporator unit, said evaporator unit comprising an evaporator coil and being disposed in a cold room of an automated, grid-based storage and retrieval system for frozen food, said system comprising an extraction fan configured to extract air from an interior of the evaporation unit to an exterior of the cold room, wherein the system is configured such that the extraction fan operates while the evaporator coil is being defrosted.

It is hereby achieved that moisture released into the interior of the evaporator unit in the course of the evaporator coil defrosting process (removing ice formed at the evaporator coil) may be evacuated quickly, even instantaneously from said unit. The proposed solution is structurally simple and easy to install/retrofit and maintain. Advantageously, availability of the evaporator unit is significantly improved by the present invention, in part because defrosting/air extraction processes run in parallel (and not sequentially) so that important time savings are achieved and in part because defrosting periods occur less frequently due to an improved air environment, i.e. less moisture, in the interior of the evaporator unit upon completion of a defrosting cycle.

Another aspect of the invention relates to a method of removing moisture from an evaporator unit in accordance with claim 21. For the sake of brevity, advantages discussed above in connection with the system for extracting air from an evaporator unit, may even be associated with the corresponding method and are not further discussed. Here, it is to be construed that the sequence of method steps of method claims may be effectuated in any given order.

For the purposes of this application, the term “container handling vehicle” used in “Background and Prior Art”-section of the application and the term “remotely operated vehicle” used in “Detailed Description of the Invention”-section both define a robotic wheeled vehicle operating on a rail system arranged across the top of the framework structure being part of an automated storage and retrieval system. Analogously, the term “storage container” used in “Background and Prior Art”-section of the application and the term “goods holder” used in “Detailed Description of the Invention”-section both define a receptacle for storing items. In this context, the goods holder can be a bin, a tote, a pallet, a tray or similar. Different types of goods holders may be used in the same automated storage and retrieval system.

The relative terms “upper”, “lower”, “below”, “above”, “higher” etc. shall be understood in their normal sense and as seen in a Cartesian coordinate system. When mentioned in relation to a rail system, “upper” or “above” shall be understood as a position closer to the surface rail system (relative to another component), contrary to the terms “lower” or “below” which shall be understood as a position further away from the rail system (relative to another component).

### BRIEF DESCRIPTION OF THE DRAWINGS

Following drawings are appended to facilitate the understanding of the invention.

The drawings show embodiments of the invention, which will now be described by way of example only, where:

FIG. 1 is a perspective view of a framework structure of a prior art automated storage and retrieval system.

FIG. 2 is a perspective view of a prior art container handling vehicle/remotely operated vehicle having a centrally arranged cavity for carrying storage containers therein.

FIG. 3a is a perspective view of a prior art container handling vehicle/remotely operated vehicle having a cantilever for carrying storage containers underneath.

FIG. 3b is a perspective view, seen from below, of a prior art container handling vehicle/remotely operated vehicle having an internally arranged cavity for carrying storage containers therein.

FIG. 4 is a schematical perspective drawing of a system for extracting air from an evaporator unit according to an embodiment of the present invention.

FIG. 5 is a schematical perspective drawing of a system for extracting air from an evaporator unit according to a second embodiment of the present invention.

FIG. 6 is a schematical perspective drawing of a system for extracting air from an evaporator unit according to a third embodiment of the present invention.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

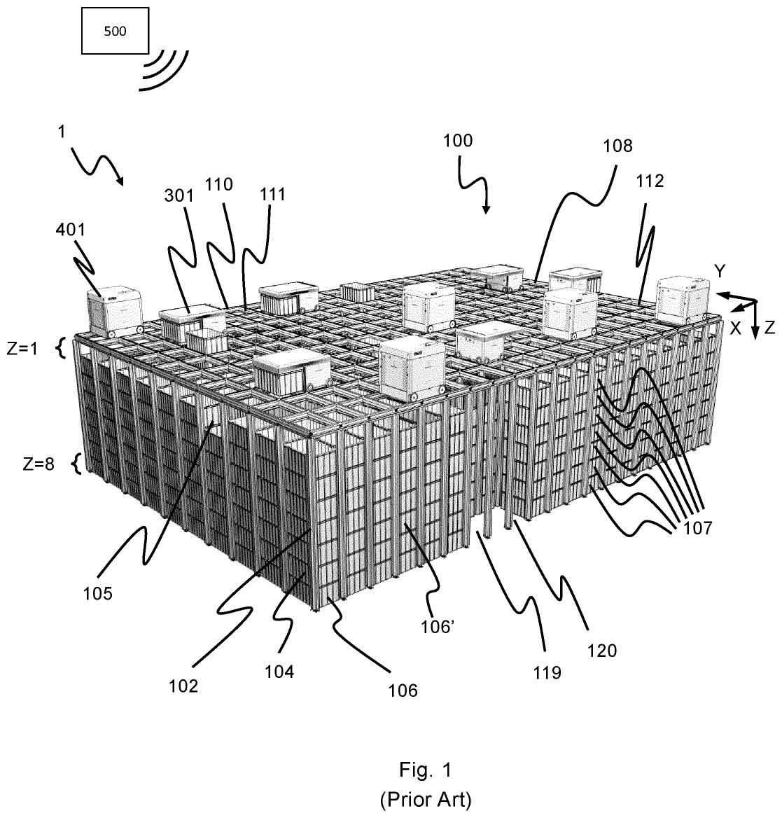

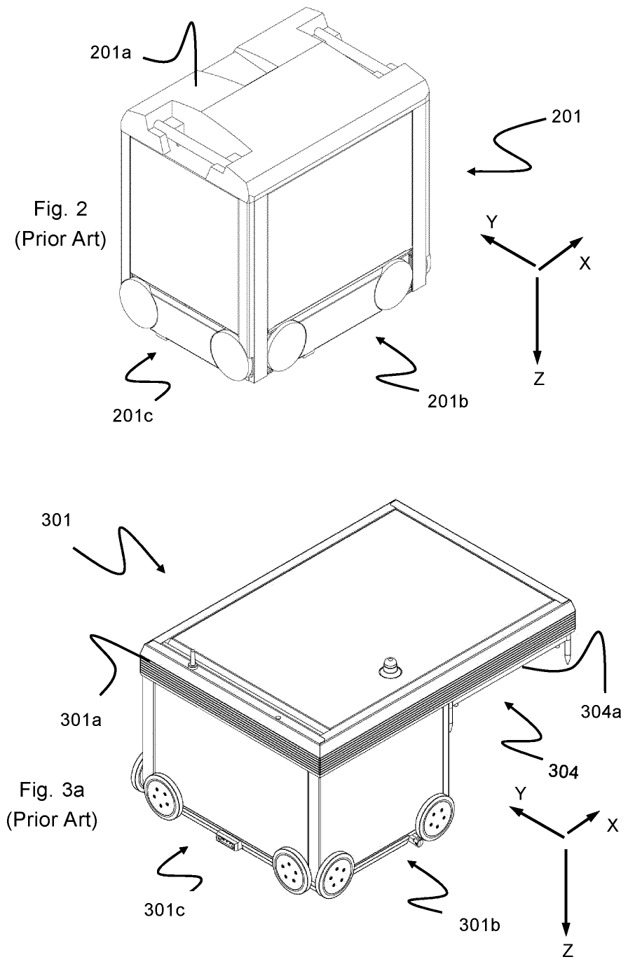

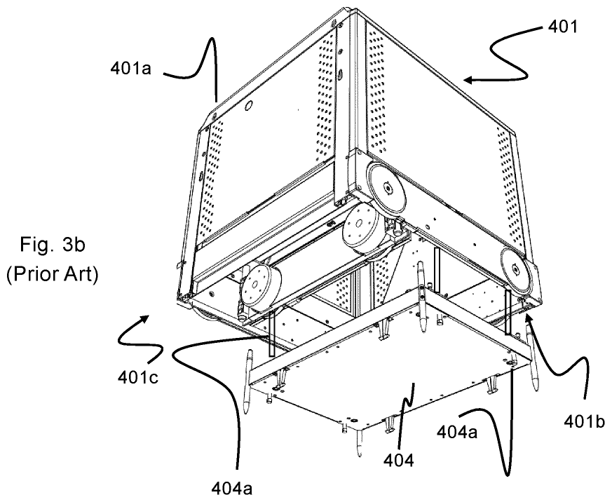

The framework structure 100 of the automated storage and retrieval system 1 is constructed in accordance with the prior art framework structure 100 described above in connection with FIGS. 1-3b, i.e. a number of upright members 102, wherein the framework structure 100 also comprises a first, upper rail system 108 in the X direction and Y direction.

The framework structure 100 further comprises storage compartments in the form of storage columns 105 provided between the members 102 where storage containers 106 are stackable in stacks 107 within the storage columns 105.

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers.

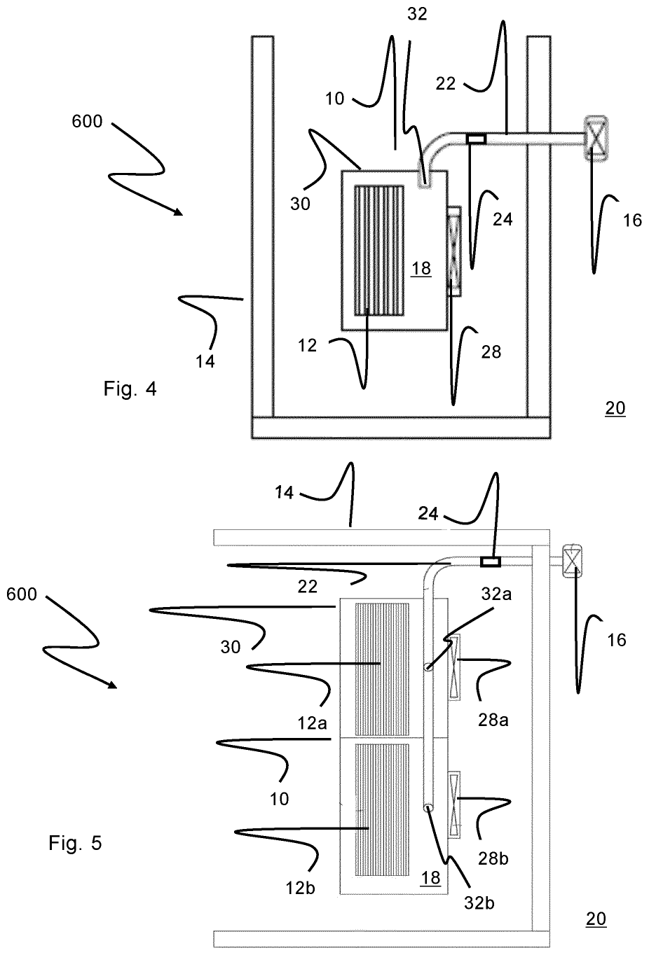

Various aspects of the present invention will now be discussed in more detail with reference to FIGS. 4-6.

FIG. 4 is a schematical perspective drawing of a system 600 for extracting air from an evaporator unit 10 according to an embodiment of the present invention. The evaporator unit 10 comprises an evaporator coil 12 and an evaporator fan 28 and is disposed in a cold room 14 of an automated, grid-based storage and retrieval system for frozen food. The cold room 14 produces cold air for the system 1 of FIG. 1 by means of the evaporator unit 10.

The system 600 shown in FIG. 4 comprises an extraction fan 16 configured to extract air from an interior 18 of the evaporator unit 10 to an exterior 20 of the cold room 14. In one embodiment, the fan 16 is an external fan. The system 600 is configured such that the extraction fan 16 operates while the evaporator coil 12 is being defrosted.

It is hereby achieved that moisture released into the interior 18 of the evaporator unit 10 in the course of the evaporator coil 12 defrosting process (removing ice formed at the evaporator coil) may be evacuated quickly, even instantaneously from said unit 10. The proposed solution is structurally simple and easy to install and maintain.

The solution is particularly advantageous in retrofit applications so as to improve performance of the evaporator unit 10. More specifically, availability of the evaporator unit 10 is significantly improved by the system at hand, in part because defrosting/air extraction processes run in parallel (and not sequentially) so that important time savings are achieved and in part because defrosting periods occur less frequently due to an improved air environment, i.e. less moisture, in the interior 18 of the evaporator unit 10 upon completion of a defrosting cycle.

A conduit 22 extending between the interior 18 of the evaporator unit 10 and the exterior 20 of the cold room 14 establishes fluid communication such that air is extracted from the interior 18 of the evaporator unit 10 to the exterior 20 of the cold room 14 via said conduit 22. In an embodiment, the conduit 22 is thermally insulated and/or heated by a thermal cable. An air extraction rate from the evaporator unit 10 is controlled by a rotary speed of the extraction fan 16.

A valve 24, typically a one-way valve, is arranged in the conduit 22 so as to prevent air flowing from the exterior 20 of the cold room 14 into the interior 18 of the evaporator unit 10. Said valve 24 has another function as it also prevents external air being sucked into the evaporator unit 10 when an evaporator fan 28 is operating. As regards operation of the valve 24, said valve 24 is predominantly closed when the evaporator coil 12 is in operation and is predominantly open when the evaporator coil 12 is being defrosted. In a related embodiment, the system 600 is configured such that the extraction fan 16 predominantly operates while the evaporator coil 12 is being defrosted.

With reference to the evaporator unit 10, said unit 10 comprises a housing 30 in which the evaporator coil 12 and the evaporator fan 28 arranged downstream to said evaporator coil 12 are disposed and wherein the interior 18 of the evaporator unit 10 corresponds to the interior of the housing 30. An air extraction opening 32 is arranged in a top wall of the evaporator unit housing 30. Said air extraction opening 32 allows air flow from the evaporator unit housing 30 into the conduit 22. In one embodiment, the air extraction opening 32 is a suction hole provided between the evaporator coil 12 and the evaporator fan 28.

FIG. 5 is a schematical perspective drawing of a system 600 for extracting air from an evaporator unit 10 according to a second embodiment of the present invention. For the sake of completeness, components discussed in conjunction with FIG. 4 are also identified and numbered in FIG. 5. In addition, the evaporator unit 10 of FIG. 5 comprises two evaporator coils 12a, 12b and two evaporator fans 28a, 28b, each coil 12a, 12b being associated to one evaporator fan 28a, 28b. Two air extraction openings 32a, 32b are arranged in a top wall of the evaporator unit housing 30. Said air extraction openings 32a, 32b allow air flow from the interior 18 of the evaporator unit housing 30 into the single conduit 22.

As presented above, the evaporator unit 10 is typically placed in a cold room 14 of an automated, grid-based storage and retrieval system 1 for goods holders containing frozen food. An example of such a storage and retrieval system 1 is shown in FIG. 1.

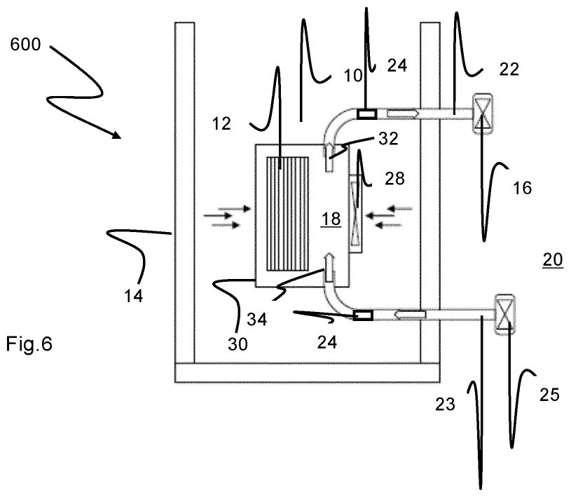

FIG. 6 is a schematical perspective drawing of a system 600 for extracting air from an evaporator unit 10 according to a third embodiment of the present invention. For the sake of completeness, components discussed in conjunction with FIG. 4 or 5 are also identified and numbered in FIG. 6. In addition, the system 600 comprises a further conduit 23 and a further fan 25. The further fan 25 is configured to introduce air from exterior 20 of the cold room 14 to interior 18 of the evaporator unit 10 via said further conduit 23. The further fan 25 is configured to operate simultaneously with the extraction fan 16 such that the amount of air in the evaporator unit 10 remains substantially constant.

With reference to FIG. 6, an air insertion opening 34 is provided in the evaporator unit housing 30, said air insertion opening 34 being arranged opposite the air extraction opening 32 of FIG. 5, i.e. in a bottom wall of the evaporator unit housing 30. The air insertion opening 34 allows air flow from the further conduit 23 to the interior 18 of the evaporator unit 10. A valve 24, typically a one-way valve, is arranged in the further conduit 23 so as to prevent air flowing from the interior 18 of the evaporator unit 10 to the exterior 20 of the cold room 14. Normally, air at a first temperature is extracted from the interior 18 of the evaporator unit 10, while air at a second, higher temperature is inserted into the interior 18 of the evaporator unit 10. Directions of air flow through the conduits 22, 23 are suitably denoted by means of block arrows and flows of air within the evaporator unit 10 are illustrated by means of leftwards and rightwards arrows. This arrangement maximizes mixing of warm and cold air inside the housing 30. Typically, air temperature in the interior 18 of the housing 30 is below −20 °C, whereas air temperature at the exterior 20 of the cold room 14, hence temperature of the inserted air, is well above 0 °C. Preferably, the extraction and the insertion of air are regulated such that an amount of air in the evaporator unit 10 substantially constant at all times.

Still with reference to FIG. 6, in an alternative embodiment (not shown) a single fan-single conduit configuration may be used for bidirectional air flow, i.e. a single fan is employed to extract and insert air via a single conduit. Obviously, the associated valve would then be a two-way valve of suitable type.

In the preceding description, various aspects of the automated, grid-based storage and retrieval system comprising a system for extracting air from an evaporator unit have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the systems, which are apparent to persons skilled in the art to which the disclosed subject matter pertains, are deemed to lie within the scope of the present invention as stated in the claims.

### LIST OF REFERENCE NUMBERS

1 Storage and retrieval system
10 Evaporator unit
12 Evaporator coil
12a, 12b Two evaporator coils
14 Cold room
16 Extraction fan
18 Interior of the evaporator unit
20 Exterior of the cold room
22 Conduit
23 Further conduit
24 Valve
25 Further fan
28 Evaporator fan
28a, 28b Two evaporator fans
30 Housing of the evaporator unit
32 Air extraction opening
32a, 32b Two air extraction openings
34 Air insertion opening
102 Upright members of framework structure
104 Storage grid
105 Storage column
106 Storage container/goods holder
106′ Particular position of storage container
107 Stack of storage containers
108 Rail system
110 Parallel rails in first direction (X)
111 Parallel rails in second direction (Y)
112 Access opening
119 First port column
201 Container handling vehicle belonging to prior art
201a Vehicle body of the container handling vehicle 201
201b Drive means/wheel arrangement, first direction (X)
201c Drive means/wheel arrangement, second direction (Y)
301 Cantilever-based container handling vehicle
301a Vehicle body of the container handling vehicle 301
301b Drive means in first direction (X)
301c Drive means in second direction (Y)
400 Air flow control device
401 Container handling vehicle belonging to prior art
401a Vehicle body of the container handling vehicle 401
401b Drive means in first direction (X)
500 Storage volume
600 System for extracting air
X First direction
Y Second direction
Z Third direction

1. A system for extracting air from an evaporator unit, said evaporator unit comprising an evaporator coil and being disposed in a cold room of an automated, grid-based storage and retrieval system for frozen food, said system comprising:
an extraction fan configured to extract air from an interior of the evaporator unit to an exterior of the cold room,
wherein the system is configured such that the extraction fan operates while the evaporator coil is being defrosted.

2. The system of claim 1, wherein a conduit establishes fluid communication between interior of the evaporator unit and exterior of the cold room such that air is extracted from the interior of the evaporator unit via said conduit.

3. The system of claim 2, wherein a valve is arranged in the conduit so as to prevent air flowing from the exterior of the cold room into the interior of the evaporator unit.

4. The system of claim 3, wherein said valve is closed when the evaporator coil is in operation and is open when the evaporator coil is being defrosted.

5. The system of claim 1, wherein an air extraction rate from the evaporator unit is controlled by a rotary speed of the extraction fan arranged external to the cold room.

6. The system of claim 2, wherein said conduit is thermally insulated and/or heated by a thermal cable.

7. The system of claim 1, wherein the system is configured such that the extraction fan only operates while the evaporator coil is being defrosted.

8. The system of claim 2, further comprising a further conduit and a further fan configured to introduce air from exterior of the cold room to interior of the evaporator unit via said further conduit.

9. The system of claim 8, wherein the further fan is configured to operate simultaneously with the extraction fan such that an amount of air in the evaporator unit remains substantially constant.

10. The system of claim 8, wherein a temperature of air being extracted from the evaporator unit is lower than the temperature of air being introduced into the evaporator unit.

11. An evaporator unit comprising an evaporator coil, said evaporator unit comprising a system in accordance with any of claims 1-10.

12. The evaporator unit of claim 11, wherein the evaporator unit further comprises an evaporator fan configured to provide cooled air to the cold room.

13-19. (canceled)

20. An automated, grid-based storage and retrieval system, said automated, grid-based storage and retrieval system comprising a framework structure comprising vertically extending members and a grid of horizontal rails provided at upper ends of said vertical members, wherein remotely operated vehicles for handling goods holders operate on top of the grid, the framework structure defining a storage volume for storing goods holders containing frozen food, the automated, grid-based storage and retrieval system comprising the evaporator unit of claim 11.

21. A method of removing moisture from an evaporator unit comprising an evaporator coil and being disposed in a cold room of an automated, grid-based storage and retrieval system for frozen food, said method comprising:
extracting air from an interior of the evaporator unit to an exterior of the cold room while the evaporator coil is being defrosted.

22. The method of claim 21, wherein an air extraction period and a coil defrosting period are equally long.

23. The method of claim 22, comprising:
temporally offsetting the air extraction period with respect to the coil defrosting period.

24. The method of claim 21, comprising:
controlling the extraction of air by means of a fan.

25. The method of claim 24, wherein said fan is external to the cold room.

26. The method of claim 21, comprising:
while extracting air at a first temperature from the interior of the evaporator unit, inserting air at a second, higher temperature into the interior of the evaporator unit.

27. The method of claim 26, comprising:
regulating the extraction and the insertion of air such that an amount of air in the evaporator unit remains substantially constant.
